(19) United States
(12) Patent Application Publication
(10) Pub. No.: US 2017/0076830 A1
(43) Pub. Date: Mar. 16, 2017

(54) ENERGY RECOVERY LINAC FOR RADIOISOTOPE PRODUCTION WITH SPATIALLY-SEPARATED BREMSSTRAHLUNG RADIATOR AND ISOTOPE PRODUCTION TARGET

(71) Applicants: David R. Douglas, Yorktown, VA (US); Rolland Paul Johnson, NewPort News, VA (US); Andrew Kimber, Poquoson, VA (US); Vasiliy S. Morozov, Yorktwon, VA (US); Amy Sy, Newport News, VA (US); Geoffrey A. Krafft, Newport News, VA (US)

(72) Inventors: David R. Douglas, Yorktown, VA (US); Rolland Paul Johnson, NewPort News, VA (US); Andrew Kimber, Poquoson, VA (US); Vasiliy S. Morozov, Yorktwon, VA (US); Amy Sy, Newport News, VA (US); Geoffrey A. Krafft, Newport News, VA (US)

(73) Assignee: Muons, Inc., Newport News, VA (US)

(21) Appl. No.: 15/143,383

(22) Filed: Apr. 29, 2016

Related U.S. Application Data
(60) Provisional application No. 62/179,232, filed on May 2, 2015.

(51) Int. Cl. G21G 1/12; H05H 7/22; H05H 9/00

(52) U.S. Cl. CPC G21G 1/12; H05H 9/00; H05H 7/22

(57) ABSTRACT

A method and electron linac system for production of radioisotopes is provided. The electron linac is an energy recovery linac (ERL) with an electron beam transmitted through a thin bremsstrahlung radiator. Isotopes are produced through bremsstrahlung photon interactions in an isotope production target that is spatially separated from the bremsstrahlung radiator. The electron beam does not pass through the isotope production target. The electron beam energy is recollected and reinjected into the linac accelerating structure. The reduction of material in the beam by removing the isotope production target and making the radiator thin is the essential aspect of the invention because large spreads in energy and transverse scattering angles caused by material in the beam preclude efficient energy recovery. The method described here can reduce the cost of energy to produce a quantity of radioisotope by more than a factor of 3 compared to a non-ERL bremsstrahlung method.

### CROSS REFERENCE TO RELATED APPLICATIONS

This patent application relates to the following provisional patent applications with their priority dates:

Appl # Priority date Title

62/179,232 May 2, 2015 ERLs for Commercial Radioisotope Production (idea of thin radiator in beam, production target outside)

62/386,950 Dec. 17, 2015 ERLs for Commercial Radioisotope Production (means of collecting scattered beam after the radiator to allow ER)

### STATEMENT OF FEDERALLY SPONSORED RESEARCH OR DEVELOPMENT

This invention was made with government support under STTR Grant DE-SC0013123 awarded by the US DOE. The government has certain rights in the invention.

The invention and work described here were supported under US DOE STTR Grant DE-SC0013123 to MuPlus, Inc., a wholly-owned subsidiary of Muons, Inc.

The names of the parties to a joint research agreement if the claimed invention was made as a result of activities within the scope of a joint research agreement.

The invention and work described here were made under CRADA JSA2015S0006 between MuPlus, Inc., a wholly-owned subsidiary of Muons, Inc., and the Thomas Jefferson National Accelerator Facility.

### REFERENCE TO A SEQUENCE LISTING

Not Applicable

### STATEMENT REGARDING PRIOR DISCLOSURES BY THE INVENTOR OR A JOINT INVENTOR

Not Applicable

### BACKGROUND OF THE INVENTION

This invention relates generally to the field of isotope production, for applications including but not limited to medical and industrial applications. This invention relates particularly to electron linear accelerators, and more specifically to an energy recovery linear accelerator in which photons are produced by the electron beam interaction with an internal bremsstrahlung radiator.

Isotope Production

Radioisotopes are increasingly pervasive across medical and industrial fields for imaging and other applications. Radioisotopes of interest for these applications are generally produced by a limited number of large facilities yielding a small variety of isotopes. Most radioisotopes in use today are generated from nuclear reactors or cyclotron accelerators. Isotopes produced in reactors are mainly from the neutron, gamma (n, γ) reaction, also known as radiative capture. By contrast, cyclotrons bombard an isotope production target with a stream of heavy, charged particles, commonly protons.

Ion or electron linear accelerators (linacs) are used to a lesser extent to generate radioisotopes. Ion linacs also typically accelerate protons into targets, and can be large and expensive to operate and maintain. Electron linacs are typically used to generate bremsstrahlung photons that generate isotopes through photoproduction channels. Electron linacs can also be used to generate isotopes using bremsstrahlung photons through the photofission process.

Electron linear accelerators typically generate radioisotopes by bombarding an isotope production target with bremsstrahlung photons. The bremsstrahlung photons are generated by the electron beam interaction with a photon radiator; bremsstrahlung or “braking radiation” is produced as charged particles are slowed down in their interaction with matter.

Electron linacs are being used to generate ⁹⁹Mo, a precursor to the medically-relevant isotope ^{99m}Tc. Niowave, Inc. is a company that is using superconducting electron linacs to produce ⁹⁹Mo from LEU targets using bremsstrahlung photons through the photofission process. The reaction is most efficient with electron beam energies of ˜40 MeV.

Electron Linacs

Electron linacs are used for radioisotope production at research and commercial institutions. A typical electron linac for radioisotope production includes an electron gun to produce electrons; focusing elements to transport and match the electron beam to an RF accelerating structure; an RF accelerating structure to accelerate the electron beam energy; a bremsstrahlung photon radiator to convert the incident electron energy to photons; and an isotope production target that will produce isotopes upon irradiation by the generated photons. Typical electron linac systems for isotope production are technically limited by the beam power that the photon radiator can absorb. A typical system operates with electron beam energies of ˜50 MeV.

Energy recovery linacs (ERLs) have applications in photon sources and electron cooling. An ERL increases the power efficiency of an electron linac system by recycling the electron beam power. The electron beam power is recycled by using a recirculating beam lattice to return the electron beam to the entrance of the RF cavities. The recirculating beam lattice is configured to return the electron beam to the accelerating structure with an RF phase delay. A proper RF phase delay allows the RF cavities to extract energy from the recirculated electron beam, and this energy is then used to accelerate a new electron bunch from the electron gun. The overall effect is reduced input RF power to the linac system.

ERLs have been proposed for use as the isotope producing electron linac in a previous invention. This previous method explicitly requires the electron beam from an ERL to pass through both the bremsstrahlung radiator and the isotope production target before being energy recovered.

A method for producing a wide range of radioisotopes with improved power efficiency, improved isotope yield, and robust machine operation is desired.

### BRIEF SUMMARY OF THE INVENTION

The present invention relates to a method and energy recovery linac for producing a wide range of radioisotopes. A principal aspect of the present invention is to provide an energy recovery linac and recirculating beam lattice that spatially separates the bremsstrahlung photon radiator and the isotope production target. This separation allows for improved photon yield compared to other ERL isotope linacs that transport the electron beam through the isotope production target.

The present invention provides a method and electron linac system for production of radioisotopes. The electron linac is an energy recovery linac (ERL) with an electron beam transmitted through a bremsstrahlung photon radiator material. The electron beam energy is extracted and recovered by the RF accelerating structure.

In accordance with features of the invention, the ERL improves the efficiency of the isotope production system by reducing the effective operating power of the system for a given electron beam energy.

In accordance with features of the invention, the preferred embodiment includes an electron gun, an RF accelerating structure, a thin bremsstrahlung photon radiator, an isotope production target, and a beam lattice that recirculates the electron beam back to the entrance of the RF accelerating cavities to extract the electron beam power.

In accordance with features of the invention, the RF accelerating structure uses superconducting cavities to allow for increased beam power limits.

In accordance with features of the invention, the electron beam in the ERL is transmitted through the thin bremsstrahlung photon radiator, and the recirculating beam lattice controls and transports the spent electron beam back to the RF accelerating structure.

In accordance with features of the invention, the thickness of the bremsstrahlung photon radiator is determined by the energy acceptance of the RF accelerating structure and the transverse angular acceptance of the recirculating beam lattice.

In accordance with features of the invention, the spent electron beam is not incident on the isotope production target. The isotope production target is spatially separated from the bremsstrahlung photon radiator.

### BRIEF DESCRIPTION OF THE DRAWINGS

FIG. 1 is a schematic illustration of an ERL system for radioisotope production with spatially separated bremsstrahlung photon radiator and isotope production target.

FIG. 2 is a chart illustrating the photon yield per incident electron as a function of thickness of a bremsstrahlung photon radiator in accordance with a preferred embodiment.

FIG. 3 is a chart illustrating the momentum distribution in the spent electron beam after the electrons have passed through a lead-bismuth eutectic radiator with a material thickness in accordance with a preferred embodiment.

FIG. 4 is a chart illustrating the truncated momentum distribution in the spent electron beam after the electrons have passed through a lead-bismuth eutectic radiator with a material thickness in accordance with a preferred embodiment.

FIG. 5 is a chart illustrating the polar angle distribution of bremsstrahlung photons emitted from a lead-bismuth eutectic radiator with a material thickness in accordance with a preferred embodiment.

### DETAILED DESCRIPTION OF THE INVENTION

The present invention provides a method and electron linac system for production of radioisotopes. The electron linac is an energy recovery linac (ERL) with an electron beam transmitted through a bremsstrahlung photon radiator material. The electron beam does not pass through the isotope production target. The electron beam energy is extracted and recovered by the RF accelerating structure.

The present invention uses ERL technology to reduce the effective input power required of the isotope production system.

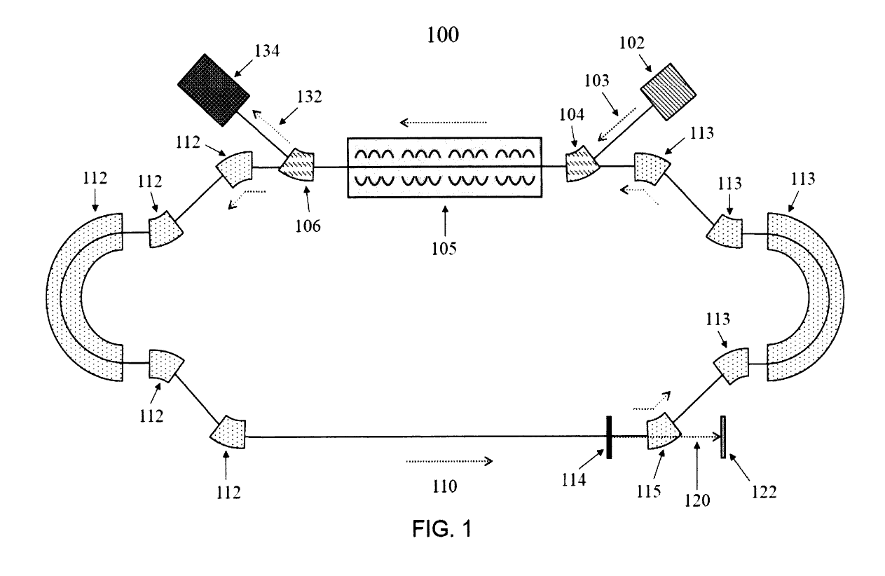

In accordance with features of the invention, the preferred embodiment includes an electron gun, an RF accelerating structure, a thin bremsstrahlung photon radiator, an isotope production target, and a beam lattice that recirculates the electron beam back to the entrance of the RF accelerating cavities to extract the electron beam power. The preferred embodiment of the present invention is illustrated in FIG. 1. The ERL system 100 generally includes an electron gun 102 that generates electrons for injection into the ERL system via injection lattice 103. Electron gun 102 may generate electrons through emission processes including but not limited to photoemission, thermionic emission, or field emission from an appropriate cathode. Merger optics system 104 transports electrons to accelerating structure 105. Accelerating structure 105 is preferably a superconducting RF system capable of accelerating electron currents of ˜10 mA to beam energy of ˜100 MeV.

Accelerated electrons exit the accelerating structure 105 through exit optics system 106 and enter recirculating beam lattice 110 that is generally defined by a plurality of focusing elements 112, 113, and 115. Recirculating beam lattice 110 controls and transports the electron beam from the accelerating structure 105 using the plurality of focusing elements 112. Recirculating beam lattice 110 then transports the electron beam through bremsstrahlung photon radiator 114. The electron beam is thereafter referred to as the spent electron beam. The spent electron beam quality is degraded by the interaction with bremsstrahlung photon radiator 114 and is restored by focusing element 115. Focusing element 115 transports the spent electron beam through a plurality of focusing elements 113 to merger optics system 104 at the entrance of accelerating structure 105. Merger optics system 104 merges the spent electron beam into the entrance of accelerating structure 105. The proper configuration of recirculating beam lattice 110 imparts an RF phase delay to the spent electron beam with respect to the operating phase of the accelerating structure 105. The phase delay is chosen such that the injected electron beam is accelerated and the spent electron beam is decelerated upon traversing the accelerating structure 105. Deceleration of the spent electron beam returns a large fraction of the beam energy to accelerating structure 105. The spent electron beam exits accelerating structure 105 to exit optics system 106. Exit optics system 106 directs the spent electron beam along the direction designated by the reference character 132. The remaining spent beam energy is deposited in beam dump 134.

Bremsstrahlung photons generated by the electron beam interaction with bremsstrahlung photon radiator 114 are generally emitted in the forward direction as designated by the reference character 120. The bremsstrahlung photons impinge upon the isotope production target 122 and produce radioisotopes through photonuclear or photofission processes. Isotope production target 122 can easily be removed and replaced without disrupting operation of the recirculating beam lattice 110.

Beam Optics and Photon Yield Calculations

An electron passing through a material can be deflected by an atomic nucleus within the material. This deflection decelerates the electron, and the lost kinetic energy of the electron is converted into a photon. This photon radiation is referred to as bremsstrahlung radiation, and the process itself is referred to as bremsstrahlung. Applications making use of bremsstrahlung radiation often refer to the material used to generate the bremsstrahlung radiation as a bremsstrahlung photon radiator or converter. The photon spectrum resulting from the bremsstrahlung process is continuous up to the incident electron energy.

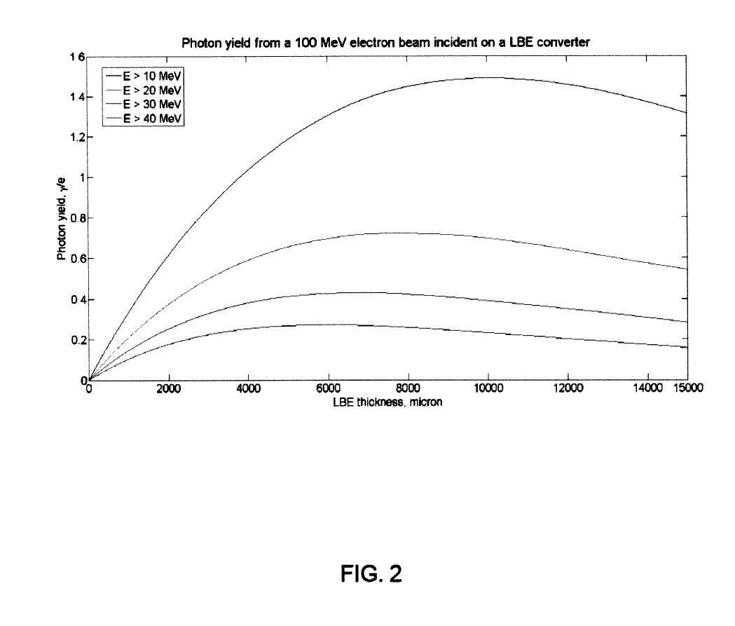

An evaluation of the proposed approach for feasibility and efficiency of the isotope production process begins with the bremsstrahlung photon yield for a given bremsstrahlung photon radiator and incident electron energy. The photon yield per incident electron as a function of bremsstrahlung radiator thickness is plotted in FIG. 2 for an electron beam of energy 100 MeV incident on a lead-bismuth eutectic (LBE) bremsstrahlung radiator. Each curve represents the photon yield for a denoted range of resultant photon energies. Each curve has a maximum value corresponding to an optimum radiator thickness beyond which the photon yield decreases. This is due to the bremsstrahlung radiation being absorbed within the radiator material. A conventional electron linac for radioisotope production utilizes radiator thicknesses near the optimum thickness for a desired range of photon energies. The optimum thickness results in the maximum photon yield per incident electron, but also results in a large energy spread and large transverse angular spread in the spent electron beam. The radiator thickness utilized in an ERL-based isotope production system must be less than this optimum thickness to limit the energy and transverse angular spreads in the spent electron beam.

An electron passing through the bremsstrahlung radiator material is deflected many times from its initial trajectory. These multiple scattering events result in increased transverse angular spread in the spent electron beam. The RMS transverse angular spread induced in the spent electron beam is given by

$${θ}_{rm s} = \frac{13.6}{E} \sqrt{\frac{w}{{X}_{0}}} ( 1 + 0.038 ln \frac{w}{{X}_{0}} )$$

where E is the incident electron beam energy in MeV; w is the material thickness; and X0 is the material radiation length. The radiation length X0 is material specific and tends to increase with increased atomic number Z, with typical values for the radiation length of appropriate radiator materials on the order of a few millimeters. Referring to FIG. 2, the optimum radiator thickness for maximum photon yield ranges from ˜5-10 mm for a 100 MeV electron beam incident on an LBE bremsstrahlung radiator. The radiation length of LBE at 1700 K is 7 mm. These parameters give RMS transverse angular spreads of 110-170 mrad, which is very challenging for robust ERL operation. The bremsstrahlung radiator thickness must be reduced to adjust the transverse angular spread to values that are more compatible with ERL operation, at the expense of the photon yield.

The allowable transverse angular spread of the spent electron beam is generally limited by the ability of the post-radiator focusing elements to control and transport the spent electron beam through the recirculation lattice. Practical limits on the transverse angular spread depend on the allowable beam size in the post-radiator focusing elements, and thus are affected by the initial beam size, beam energy, and bremsstrahlung radiator thickness. From the equation for the RMS transverse angular spread, it is easily seen that higher beam energies and thinner radiators are favorable for minimizing the angular spread. A possible implementation of the proposed invention accelerates electrons up to 100 MeV through a bremsstrahlung radiator of thickness w that is a few (3-4) percent of the material radiation length. This gives an RMS transverse angular spread of 20 mrad, which is more easily controlled in the recirculation lattice.

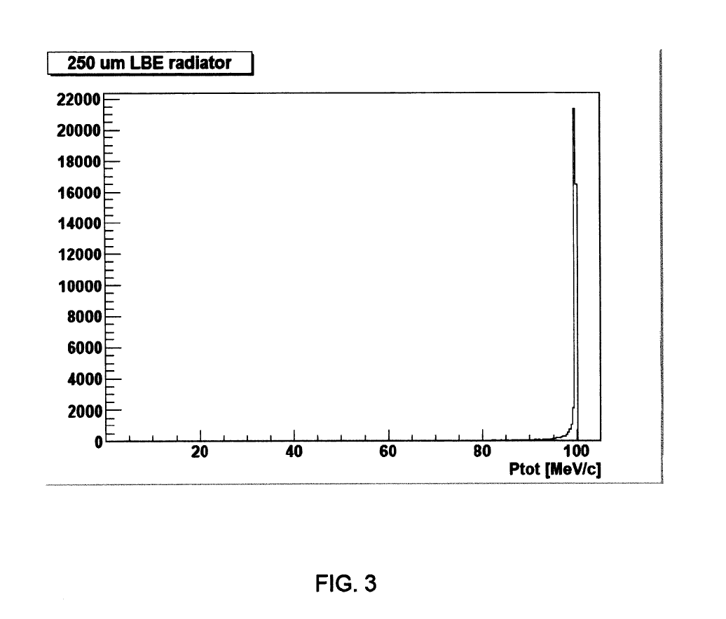

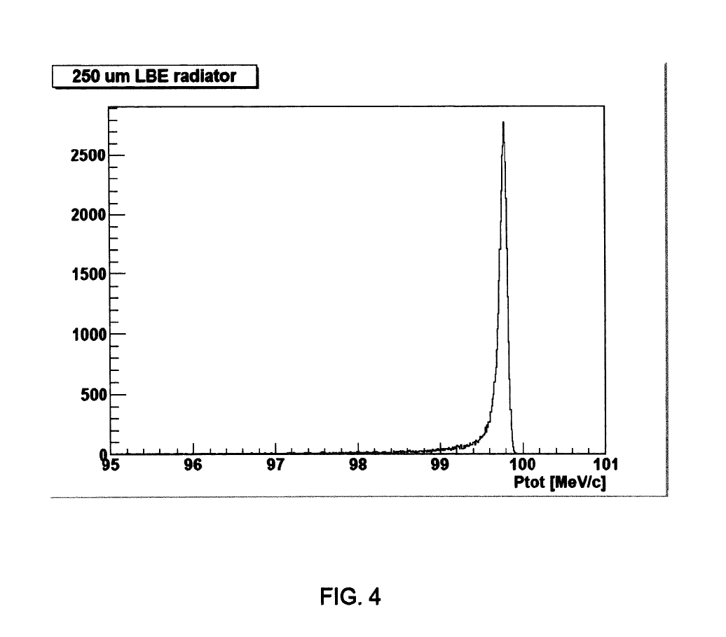

The multiple scattering of electrons in the bremsstrahlung radiator material also imparts an energy spread to the spent electron beam. The induced energy spread in the spent electron beam also depends on radiator thickness. Electrons passing through a bremsstrahlung radiator of thickness w survive with an average energy E given by

$$E = {E}_{0} exp ( - \frac{w}{{X}_{0}} )$$

where E0 is the incident electron energy, and w and X0 are as defined earlier. For radiator thicknesses of a few percent of the radiation length (to maintain small transverse angular spread), the average energy loss of the spent electron beam is commensurate with the radiator thickness—a radiator with thickness of 3% of the material radiation length results in 3% total average beam energy loss. The total average energy loss is integrated over the entire electron energy distribution. The peak of the distribution is skewed towards the incident beam energy, and the full-width at half maximum (FWHM) of the peak is a fraction of a percent. These characteristics of the electron energy distribution for electrons passing through a bremsstrahlung radiator with thickness of a few percent of the radiation length can be seen in FIG. 3 and FIG. 4. FIG. 3 and FIG. 4 are obtained using a well-known physics code. FIG. 3 shows the simulated momentum distribution for 100 MeV/c electrons passing through a 0.25 mm (3.5%) LBE radiator. The distribution peaks at 99.5 MeV/c, with an average value of 96.5 MeV/c, agreeing with the analytical estimate for the average energy loss. FIG. 4 shows a truncated plot of the same distribution as in FIG. 3. The truncated distribution clearly demonstrates the high energy and narrow width of the peak of the distribution. Over 90% of the spent electron beam falls within the energy spread range of recent operational ERL machines and is considered to be energy recoverable. The resultant spent electron beam is compatible with state-of-the-craft ERL operation with proper design of the recirculation lattice.

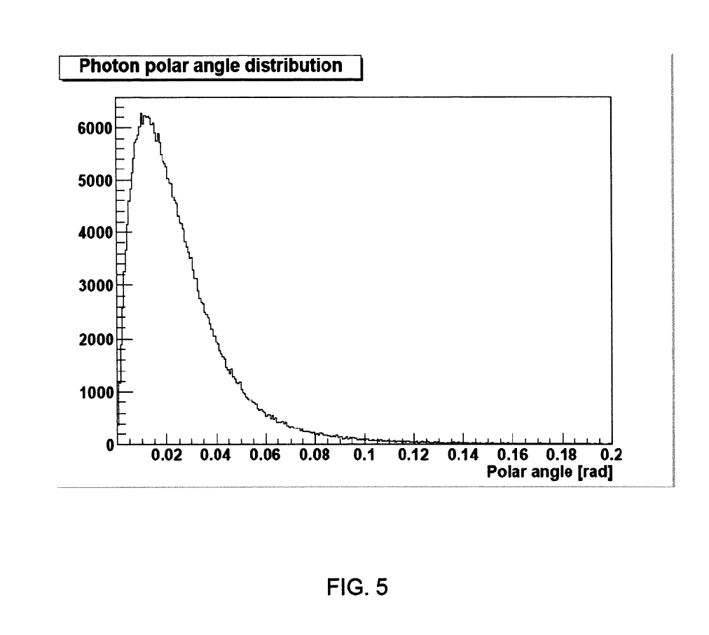

The photon yields obtainable from the proposed invention are plotted in FIG. 2 and confirmed through simulation using a well-known physics code. Higher energy incident electron beams improve the photon flux at the isotope production target through increased photon yields and narrower photon beams. For incident electron energy of 100 MeV, the bremsstrahlung photon angular distribution is forward-directed, with an RMS transverse angular spread generally commensurate with that of the spent electron beam. FIG. 5 shows the polar angle distribution for bremsstrahlung photons generated using 100 MeV electrons passing through a 3.5% LBE radiator. The peak value of the distribution at ˜10 mrad indicates that the bremsstrahlung photons are strongly forward-directed, with an RMS transverse angular spread less than that of the spent electron beam.

The isotope production target material can be optimized for a radioisotope of interest. The large range of bremsstrahlung photon energies available for irradiation of the isotope production target results in flexibility in selecting radioisotopes that are most efficiently produced through photonuclear or photofission processes.

The separation of the bremsstrahlung radiator from the isotope production target in the proposed invention has several advantages over previous inventions. The bremsstrahlung radiator thickness can be maximized for photon yield, up to the limit imposed by operational considerations for the ERL. No considerations need to be made regarding the additional transverse angular and energy spread that is induced in the spent electron beam by passage through an isotope production target. Furthermore, an isolated isotope production target allows flexibility in the target design. The isotope production target will not be constrained by operational considerations for the ERL, and will not require active cooling to handle the heat load from the spent electron beam.

### REFERENCES CITED

### U.S. Patent Documents

U.S. Pat. No. 9,129,714 B2 Sep. 2015 Noonan et al.

### Other Publications

L. Merminga, D. R. Douglas, and G. A. Krafft, “High-Current Energy-Recovering Electron Linacs”, Annu. Rev. Nucl. Part. Sci. 53, 387-429 (2003).
S. P. Karasyov et al., “Subsystem for Control of Isotope Production with Linear Electron Accelerator,” (2001).
N. I. Ayzatskiy et al., “Comparison of Cu-67 Production at Cyclotron and Electron Accelerator,” Cyclotrons and Their Applications 2007, 243-245 (2007).
G. Neil et al., “Sustained Kilowatt Lasing in a Free-Electron Laser with Same-Cell Energy Recovery,” Phys. Rev. Lett. 84, 662 (2000).
G. Loi et al., “Neutron production from a mobile linear accelerator operating in electron mode for intraoperative radiation therapy,” Phys. Med. Biol. 51, 695-702 (2006).
J. L. Matthews et al., “The distribution of electron energy losses in thin absorbers,” NIMS 180, 573-579 (1981).
B. Nordell and A. Brahme, “Angular distribution and yield from bremsstrahlung targets,” Phys. Med. Biol. 29, 797-810 (1984).
K. A. Olive et al. (Particle Data Group), “Review of Particle Physics,” Chin. Phys. C, 38, 090001 (2014).

1. An isotope-producing electron linac system comprising:
An energy recovery linac (ERL);
Spatially-separated bremsstrahlung photon radiator and isotope production target;
A recirculation lattice enabling energy recovery of electron beam after electrons pass through the bremsstrahlung photon radiator.

2. The isotope-producing electron linac system as recited in claim 1 includes a superconducting radio-frequency (SRF) gun.

3. The isotope-producing electron linac system as recited in claim 1 wherein said ERL contains an SRF accelerating structure.

4. The isotope-producing electron linac system as recited in claim 1 wherein said bremsstrahlung photon radiator is of a maximum thickness compatible with transverse angular spread and energy spread acceptances of said recirculation lattice.

5. The isotope-producing electron linac system as recited in claim 1 wherein said isotope production target absorbs bremsstrahlung photons and generates radioisotopes through photonuclear or photofission processes.

6. The isotope-producing electron linac system as recited in claim 1 wherein said recirculation lattice includes focusing elements to control and return the spent electron beam to the entrance of the SRF accelerating structure.

7. The isotope-producing electron linac system as recited in claim 1 wherein the spent electron beam energy is recovered by the SRF accelerating structure by decelerating said spent electron beam.

8. The isotope-producing electron linac system as recited in claim 1 wherein said recirculation lattice transports the decelerated spent electron beam into a beam dump.
